(19) United States
(12) Patent Application Publication
(10) Pub. No.: US 2026/0106212 A1
(43) Pub. Date: Apr. 16, 2026

(54) LITHIUM SECONDARY BATTERY

(71) Applicant: SK ON CO., LTD., Seoul (KR)

(72) Inventors: Yeon Hwa SONG, Daejeon (KR); Jae Ram KIM, Daejeon (KR); Ji Hee BAE, Daejeon (KR); Jeong Seok YEON, Daejeon (KR); Myung Ro LEE, Daejeon (KR)

(21) Appl. No.: 19/353,076

(22) Filed: Oct. 8, 2025

(30) Foreign Application Priority Data
Oct. 11, 2024 (KR) 10-2024-0138163

(51) Int. Cl. H01M 10/056; H01M 4/02; H01M 4/40; H01M 4/505; H01M 4/525; H01M 4/58

(52) U.S. Cl. CPC H01M 10/056; H01M 4/405; H01M 4/505; H01M 4/525; H01M 4/5825; H01M 2004/021; H01M 2300/002; H01M 2300/0091

(57) ABSTRACT

A lithium secondary battery includes a cathode, an anode and non-aqueous electrolyte solution. The cathode includes a cathode active material layer that includes a first cathode active material including lithium metal phosphate particles, and a second cathode active material including lithium transition metal oxide particles. The anode faces the cathode. The non-aqueous electrolyte solution includes an organic solvent and a lithium salt. A weight ratio of the first cathode active material relative to the second cathode active material in the cathode active material layer is in a range from 1.5 to 9. A concentration of the lithium salt in the non-aqueous electrolyte solution exceeds 1 M.

### CROSS-REFERENCE TO RELATED APPLICATION AND CLAIM OF PRIORITY

This application claims priority to Korean Patent Application No. 10-2024-0138163 filed on Oct. 11, 2024 in the Korean Intellectual Property Office (KIPO), the entire disclosure of which is incorporated by reference herein.

### TECHNICAL FIELD

The disclosure of this patent application relates to a lithium secondary battery.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of eco-friendly vehicle such as an hybrid vehicle.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

For example, the lithium secondary battery may include an electrode assembly including a cathode, an anode and a separator, and an electrolyte solution impregnating the electrode assembly.

The cathode may include a cathode current collector and a cathode active material layer formed on the cathode current collector. The cathode active material layer may include a lithium metal oxide as a cathode active material.

For example, the cathode active material may include lithium cobalt oxide (LiCoO₂); lithium nickel oxide (LiNiO₂); lithium manganese oxide (LiMnO₂, LiMn₂O₄, etc.); a lithium iron phosphate compound (LiFePO₄); an NCM-based lithium metal oxide containing nickel, cobalt and manganese; an NCA-based lithium metal oxide containing nickel, cobalt and aluminum, etc.

### SUMMARY

According to an aspect of the present disclosure, there is provided a lithium secondary battery having improved operational stability and electrochemical properties.

A lithium secondary battery includes a cathode, an anode and non-aqueous electrolyte solution. The cathode includes a cathode active material layer that includes a first cathode active material including lithium metal phosphate particles, and a second cathode active material including lithium transition metal oxide particles. The anode faces the cathode. The non-aqueous electrolyte solution includes an organic solvent and a lithium salt. A weight ratio of the first cathode active material relative to the second cathode active material in the cathode active material layer is in a range from 1.5 to 9. A concentration of the lithium salt in the non-aqueous electrolyte solution exceeds 1 M.

In some embodiments, the lithium metal phosphate particles may contain manganese.

In some embodiments, the lithium transition metal oxide particles may have a single particle shape.

In some embodiments, a molar ratio of nickel based on total moles of metal elements excluding lithium contained in the lithium transition metal oxide particles may be 0.8 or less.

In some embodiments, a molar ratio of nickel based on total moles of metal elements excluding lithium contained in the lithium transition metal oxide particles may be in a range from 0.5 to 0.7.

In some embodiments, the weight ratio of the first cathode active material relative to the second cathode active material in the cathode active material layer may be in a range from 1.7 to 4.

In some embodiments, an average particle diameter (D50) of the first cathode active material may be in a range from 0.3 μm to 1.5 μm.

In some embodiments, a specific surface area of the first cathode active material is in a range from 10 m²/g to 17 m2/g.

In some embodiments, an average particle diameter (D50) of the second cathode active material may be in a range from 2 μm to 10 μm.

In some embodiments, the lithium salt may include lithium tetrafluoroborate (LiBF₄), lithium hexafluorophosphate (LiPF₆) and/or lithium difluorophosphate (LiPO₂F₂).

In some embodiments, a concentration of the lithium salt in the non-aqueous electrolyte solution may be in a range from 1.05 M to 1.15 M.

In some embodiments, the organic solvent may include propylene carbonate (PC), ethylene carbonate (EC), butylene carbonate, diethyl carbonate (DEC), dimethyl carbonate (DMC) and/or ethylmethyl carbonate (EMC).

In some embodiments, the non-aqueous electrolyte solution may further include an additive including a cyclic carbonate compound, a fluorine-substituted carbonate compound, a sultone compound, a cyclic sulfate compound, a cyclic sulfite compound, a phosphate compound and/or a borate compound.

In some embodiments, the additive may include vinylene carbonate (VC), vinyl ethylene carbonate (VEC), fluoroethylene carbonate (FEC), lithium difluoro phosphate (LiDFP), 1,3-propane sultone, and/or 1,3-propene sultone.

In some embodiments, a content of the additive may be in a range from 0.1 wt % to 10 wt % based on a total weight of the non-aqueous electrolyte solution.

A lithium secondary battery according to embodiments of the present disclosure may include a cathode that may include a first cathode active material including lithium metal phosphate particles and a second cathode active material including lithium transition metal oxide particles. Accordingly, operation stability and thermal stability of the lithium secondary battery may be improved.

The cathode may include the first cathode active material and the second cathode active material in predetermined amounts. Thus, electrochemical properties and operation stability of the lithium secondary battery may be improved.

The lithium secondary battery according to embodiments may include a non-aqueous electrolyte solution containing a predetermined amount of a lithium salt. Accordingly, side reactions with the non-aqueous electrolyte solution may be suppressed while promoting intercalation/deintercalation of lithium in the cathode active material. Thus, a capacity retention may be increased while further enhancing capacity and power properties of the lithium secondary battery.

### BRIEF DESCRIPTION OF THE DRAWINGS

FIGS. 1 and 2 are a schematic plan view and a cross-sectional view, respectively, illustrating a lithium secondary battery in accordance with example embodiments.

### DETAILED DESCRIPTION OF THE EMBODIMENTS

According to embodiments of the present disclosure, a lithium secondary battery (hereinafter, that may be abbreviated as a secondary battery) including a cathode, an anode, and an electrolyte solution is provided.

The lithium secondary battery of the present disclosure may be widely applied in green technology fields such as an electric vehicle, a battery charging station, a solar power generation, a wind power generation, etc., using a battery, etc. The lithium secondary battery according to the present disclosure may be used for eco-friendly electric vehicles and hybrid vehicles to prevent a climate change by suppressing air pollution and greenhouse gas emissions, etc.

Hereinafter, embodiments of the present disclosure will be described in more detail. However, the drawings and embodiments attached to the present specification are intended to enhance understanding the technical idea of the present disclosure, and the concepts of the present invention are not to be construed as being limited to those described in such drawings and embodiments.

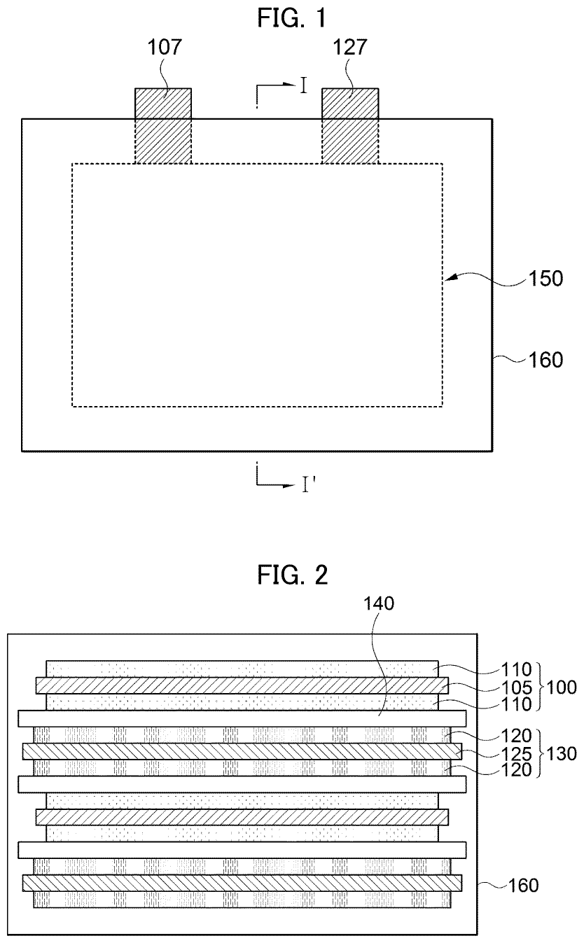

FIGS. 1 and 2 are a schematic plan view and a cross-sectional view, respectively, illustrating a lithium secondary battery in accordance with example embodiments.

Referring to FIGS. 1 and 2, the secondary battery may include a cathode 100, an anode 130, and an electrolyte solution (not illustrated).

In example embodiments, the cathode 100 may include a cathode active material layer 110 on at least one surface of a cathode current collector 105. The cathode active material layer 110 may include a cathode active material. For example, the cathode active material may include lithium metal oxide particles capable of implementing reversible insertion and deintercalation of lithium ions.

In example embodiments, the cathode active material may include a first cathode active material including lithium metal phosphate particles.

In some embodiments, the lithium metal phosphate particle may include a lithium metal phosphate.

The lithium metal phosphate has an olivine structure to have high thermal and chemical stability. For example, the lithium metal phosphate may suppress heat generation or thermal runaway in instantaneous high voltage or high current environment during charge and discharge of the secondary battery.

For example, the olivine structure may have high structural stability. Thus, generation of cracks or damages due to side reactions with the electrolyte solution or a physical impact during repeated charge/discharge cycles may be suppressed. Thus, cycle properties of the first cathode active material at high temperature or low temperature may be improved, and an electrode density may be increased.

For example, lithium ions in the lithium metal phosphate may exist in octahedral sites within an oxygen array having a hexagonal close-packed structure. Accordingly, the lithium ions may migrate along an one-dimensional path by the octahedral sites. Thus, the migration path of the lithium ions may be increased and a diffusion rate may be decreased, thereby reducing an electrical conductivity of the first cathode active material.

In some embodiments, the lithium metal phosphate may contain manganese. For example, some of iron (Fe) atoms present in the octahedral sites of the lithium metal phosphate may be substituted with a manganese (Mn) atom. For example, manganese may have a higher energy level than that of iron. Accordingly, the lithium metal phosphate containing manganese may have improved energy density. Thus, capacity properties of the secondary battery may be improved while enhancing thermal stability.

In some embodiments, the lithium metal phosphate particle may be represented by Chemical Formula 1 or Chemical Formula 1-1 below.

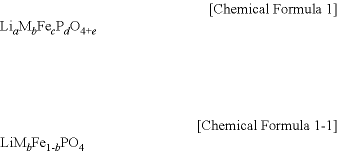

In Chemical Formula 1 or Chemical Formula 1-1, 0.9≤a≤1.2, 0.5≤b≤0.9, 0.1≤c≤0.5, 0.9≤d≤1.2, −0.1≤e≤0.1, and M may include at least one selected from the group consisting of Ni, Co, Mn, Al, Mg, Y, Zn, In, Ru, Sn, Sb, Sr, Ti, Te, Nb, Mo, Cr, Zr, W, Ir and V.

In some embodiments, in Chemical Formula 1 or Chemical Formula 1-1, M may include manganese (Mn). For example, the lithium metal phosphate particle may include a lithium-manganese iron phosphate oxide represented by LiMn_{b}Fe_{1-b}PO₄ (0.5≤b≤0.9). Accordingly, the cathode active material having improved energy density and thermal stability may be provided.

In one embodiment, b in Chemical Formula 1 or Chemical Formula 1-1 may be in a range from 0.5 to 0.9 or from 0.6 to 0.8.

The chemical structure represented by Chemical Formula 1 or Chemical Formula 1-1 represent bonding relationships included in the crystal structures of the first cathode active material or the lithium iron phosphate oxide particle, and do not exclude other additional elements. For example, M may include Mn, Mn may serve as main active elements of the first cathode active material together with Fe and P. Chemical Formula 1 or Chemical Formula 1-1 is provided to express the bonding relationship of the main active elements, and are to be understood as formulae encompassing introduction and substitution of the additional elements.

In an embodiment, an auxiliary element may be further included in addition to the main active element to enhance chemical stability of the first cathode active material or the crystal structure. The auxiliary element may be incorporated in the crystal structure to form a bond, and this case is to be understood as being included within the chemical structure represented by Chemical Formula 1 or Chemical Formula 1-1.

The auxiliary element may include, e.g., at least one of Na, Mg, Ca, Sr, Ba, La, Y, Ti, Zr, Hf, V, Nb, Ta, Cr, Mo, W, Mn, Co, Fe, Cu, Ag, Zn, B, Al, Ga, C, Si or Sn.

In an embodiment, the first cathode active material may further include a doping element. For example, elements substantially the same as or similar to the above-describe auxiliary elements may be used as the doping element. For example, the above-mentioned elements may be used alone or in a combination of two or more therefrom as the doping element.

In some embodiments, an average particle diameter (D50) of the first cathode active material may be in a range from 0.3 μm to 1.5 μm. For example, the average particle diameter (D50) may represent a diameter of particles corresponding to 50% base on a volumetric particle size distribution.

In an embodiment, the average particle diameter of the first cathode active material may be in a range from 0.5 μm to 1.2 μm, or from 0.5 μm to 1.0 μm. In this range, a lithium ion transfer rate in the first cathode active material may be increased, and the electrode density may also be increased. Accordingly, the power and capacity properties of the secondary battery may be further improved.

In some embodiments, a specific surface area of the first cathode active material may be in a range from 10 m²/g to 17 m²/g. For example, the specific surface area may be measured using a nitrogen adsorption method or a Brunauer Emmett Teller (BET) method.

For example, if the specific surface area of the first cathode active material increases, an amount of gas generated due to the side reactions with the electrolyte solution may be excessively increased.

In an embodiment, the specific surface area of the first cathode active material may be in a range from 10 m²/g to 16 m²/g, from 12 m²/g to 15 m²/g, or from 13 m²/g to 14 m²/g. In this range, the side reactions between the first cathode active material and the electrolyte solution may be further suppressed while providing improved capacity and life-span properties.

According to some embodiments, a carbon coating may be formed on at least a portion of a surface of the lithium metal phosphate particle. Accordingly, an additional ion conduction path in the first cathode active material may be provided, thereby further improving the electrical conductivity. Additionally, the side reactions between the first cathode active material and the electrolyte solution may be further suppressed. Thus, the capacity and power properties of the secondary battery may be further enhanced.

In some embodiments, a content of the first cathode active material included in the cathode active material layer 110 may be in a range from 60 weight percent (wt %) to 90 wt %, from 62 wt % to 88 wt %, or from 65 wt % to 85 wt % based on a total weight of the cathode active material layer 110. In this range, thermal stability and structural stability of the cathode active material may be further increased.

In example embodiments, the cathode active material may include a second cathode active material comprising lithium transition metal oxide particles.

The lithium transition metal oxide particles may include a lithium-nickel metal oxide. The lithium-nickel metal oxide may further include at least one of cobalt (Co), manganese (Mn) and aluminum (Al).

In some embodiments, the second cathode active material may include lithium transition metal oxide particles having a layered structure represented by Chemical Formula 2.

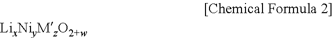

In Chemical Formula 2, 0.9≤x≤1.2, 0.4≤y≤0.99, 0.01≤z≤0.6, and −0.5≤w≤0.1. M′ may include one or more element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn or Sr.

In an embodiment, the lithium transition metal oxide particles may include a nickel-cobalt-manganese (NCM)-based lithium oxide.

For example, nickel may be provided as a metal associated with the capacity of the lithium secondary battery. A higher nickel content may improve the capacity and power properties of the lithium secondary battery. However, if the nickel content increases excessively, the life-span, and mechanical and electrical stability may be degraded. For example, if the nickel content increases, defects such as ignition or short-circuit may not be sufficiently suppressed when the secondary battery is penetrated by an external object, and sufficient capacity retention may not be provided during repeated charge/discharge cycles at high temperature (e.g., 60° C. or higher).

For example, cobalt (Co) may improve a conductivity or reduce a resistance of the lithium secondary battery, and manganese (Mn) may improve mechanical and electrical stability of the lithium secondary battery.

In some embodiments, a ratio (y) of moles of nickel relative to total moles of metal elements excluding lithium contained in the lithium transition metal oxide particles may be 0.8 or less. For example, in Chemical Formula 2, 0.4≤y≤0.8, and 0.2≤z≤0.6.

For example, if the nickel content increases excessively, penetration or ignition stability may be degraded, and the capacity retention may be lowered during repeated charge/discharge cycles at high temperature. Further, a decrease in the nickel content may lower the capacity properties.

In an embodiment, the ratio (y) of moles of nickel relative to the total moles of metal elements excluding lithium contained in the lithium transition metal oxide particles may be in a range from 0.5 to 0.7, or from 0.55 to 0.65. For example, in Chemical Formula 2, 0.5≤y≤0.7, and 0.3≤z≤0.5. In this range, the electrical conductivity of the cathode active material may be increased, and mechanical stability may be further enhanced. Accordingly, the capacity and power properties of the secondary battery at high temperature may be achieved while enhancing the capacity retention.

The chemical structure represented by Chemical Formulae 2 may represent bonding relationships included in the crystal structure of the second cathode active material or the lithium transition metal oxide particle, and do not exclude other additional elements. For example, in Chemical Formula 2, M′ may include Co and/or Mn, and Co and/or Mn may serve as main active elements of the second cathode active material together with Ni. Chemical Formula 2 is provided to express the bonding relationship of the main active elements, and are to be understood as a formula encompassing introduction and substitution of the additional elements.

In an embodiment, an auxiliary element and/or a doping element may be further included in addition to the main active element to enhance chemical stability of the second cathode active material or the crystal structure. The auxiliary element/doping element may be incorporated in the crystal structure to form a bond, and this case is to be understood as being included within the crystal structure represented by Chemical Formula 2.

The auxiliary element/doping element included in the second cathode active material may include at least one of the auxiliary elements described above in the first cathode active material.

In some embodiments, the lithium transition metal oxide particles may have a single particle shape. Accordingly, cracks of the lithium transition metal oxide particles during repeated charge/discharge cycles may be reduced, and side reactions with the electrolyte solution may be suppressed. Thus, the secondary battery having improved the capacity and life-span properties may be provided.

The term “single particle shape” herein is used to exclude a secondary particle formed by agglomeration of a plurality of primary particles. For example, a form in which a single primary particle exists as a substantially independent active material particle may be referred to as the “single particle shape.” For example, the lithium transition metal oxide particles may substantially consist of particles of the single particle shape, and the secondary particle structure in which the primary particles are assembled or aggregated may be excluded.

For example, the term “single particle shape” used herein does not exclude a form in which, e.g., 2 to 10 single particles are simply adjacent to or in contact with each other to form a monolith shape.

In some embodiments, multiple particles of the single particle shape (less than 10 single particles) may be adjacent to each other and adhered together (e.g., in a cross-sectional image of a scanning electron microscope (SEM) of the cathode active material layer). The above shape is not excluded from the single particle shape.

In some embodiments, the lithium transition metal oxide particle may include a structure in which multiple primary particles are merged into the single particle and substantially converted into the single particle.

For example, the lithium transition metal oxide particle may have a granular or spherical single particle shape.

For example, the lithium transition metal oxide particle may include a nickel-cobalt-manganese (NCM)-based lithium oxide in the single particle shape. Accordingly, the capacity and power properties of the secondary battery may be improved while further enhancing mechanical stability.

In some embodiments, an average particle diameter (D50) of the second cathode active material may be in a range from 2 μm to 10 μm. In an embodiment, the average particle diameter of the second cathode active material may be in a range from 2.5 μm to 8 μm, or from 3 μm to 5 μm. In this range, the lithium transition metal oxide particle in the single particle shape may be obtained, and high-capacity and high-power properties of the second cathode active material may be implemented.

In some embodiments, a content of the second cathode active material included in the cathode active material layer 110 may be in a range from 10 wt % to 40 wt %, from 12 wt % to 38 wt %, or from 15 wt % to 35 wt % based on the total weight of the cathode active material layer 110. In this range, the electrical conductivity of the cathode active material may be further improved, and the secondary battery having improved power properties and capacity properties may be provided.

For example, if the cathode active material does not include the lithium metal phosphate particles, structural stability of the cathode active material may not be sufficiently provided. Accordingly, an amount of gas generated due to the side reactions with the electrolyte solution may be increased. The capacity retention of the secondary battery may also be degraded.

For example, if the cathode active material above does not include the lithium transition metal oxide particles, the electrical conductivity of the cathode active material may be reduced. Accordingly, high-capacity and high-power properties of the secondary battery may not be easily implemented.

In example embodiments, the cathode active material may include both the lithium metal phosphate particles and the lithium transition metal oxide particles. Accordingly, the secondary battery having the high-capacity and high-power properties and having improved mechanical stability may be provided.

In example embodiments, a weight ratio of the first cathode active material relative to the second cathode active material in the cathode active material layer 110 may be in a range from 1.5 to 9. In the above range, mechanical stability may be obtained while increasing the electrical conductivity of the cathode active material. Accordingly, the capacity retention, high-power and high-capacity properties at high temperature of the secondary battery may be implemented.

For example, if the weight ratio of the first cathode active material relative to the second cathode active material in the cathode active material layer 110 is less than 1.5, the side reaction between the cathode active material and the electrolyte solution may be excessively increased. Accordingly, the capacity retention at high temperature of the secondary battery may be reduced, and cycle properties may be degraded.

For example, when the weight ratio of the first cathode active material relative to the second cathode active material in the cathode active material layer 110 is greater than 9, the resistance of the cathode active material may be excessively increased.

In some embodiments, the weight ratio of the first anode active material relative to the second anode active material in the cathode active material layer 110 may be in a r 1.5 to 8, from 1.5 to 5, from 1.7 to 4, from 1.8 to 3, from 2.1 to 2.5, or from 2.2 to 2.4. In the above range, the energy density may be increased by the lithium transition metal oxide particles while improving structural stability by the lithium metal phosphate particles. Accordingly, the secondary battery having more improved mechanical stability and electrochemical properties at high temperature may be provided.

In example embodiments, the cathode active material layer 110 may further include a binder, a conductive material, a dispersive agent, or the like.

For example, the above-described cathode active material may be mixed and stirred with the binder, the conductive material, the dispersive agent, etc., to prepare a slurry. The slurry may be coated on the cathode current collector 105, and then dried and pressed to form the cathode 100.

The binder may include, e.g., an organic binder such as vinylidene fluoride-hexafluoropropylene copolymer (PVDF-co-HFP), polyvinylidene fluoride (PVDF), polyacrylonitrile, polymethylmethacrylate, etc., or an aqueous binder such as styrene-butadiene rubber (SBR).

For example, a PVDF-based binder may be used as a cathode binder. In this case, an amount of the binder for forming the cathode active material layer 110 may be reduced, and an amount of the cathode active material may be relatively increased, thereby improving power and capacity of the secondary battery.

The conductive material may be included to promote an electron transfer between active material particles. For example, the conductive material may include a carbon-based conductive material such as graphite, carbon black, graphene and a carbon nanotube, and/or a metal-based conductive material including such as tin, tin oxide, titanium oxide and a perovskite material including LaSrCoO₃, LaSrMnO3, etc.

The cathode current collector 105 may include stainless steel, nickel, aluminum, titanium, or an alloy thereof. The cathode current collector 105 may also include aluminum or stainless steel surface-treated with carbon, nickel, titanium or silver.

The anode 130 may include an anode current collector 125, and an anode active material layer 120 formed by coating an anode active material on the anode current collector 125.

The anode active material widely known in the art capable of absorbing and desorbing lithium ions may be used without any specific limitation. For example, a carbon-based material such as a crystalline carbon, an amorphous carbon, a carbon composite and a carbon fiber; a lithium alloy; silicon or tin, or the like, may be used.

Examples of the amorphous carbon include hard carbon, coke, a mesocarbon microbead (MCMB) fired at a temperature of 1,500° C. or less, and a mesophase pitch-based carbon fiber (MPCF).

Examples of the crystalline carbon include a graphite-based carbon such as natural graphite, artificial graphite, a graphitized coke, a graphitized MCMB and a graphitized MPCF. Elements included in the lithium alloy include aluminum, zinc, bismuth, cadmium, antimony, silicon, lead, tin, gallium or indium.

The anode current collector 125 may include, e.g., gold, stainless steel, nickel, aluminum, titanium, copper or an alloy thereof, and preferably may include copper or a copper alloy.

In some embodiments, a slurry may be prepared by mixing and stirring a binder, a conductive material and/or a dispersive agent with the anode active material in a solvent. The slurry may be coated on at least one surface of the anode current collector 125, and then dried and pressed to prepare the anode 130.

Materials substantially the same as or similar to those used in the cathode active material layer 110 may also be used as the bonder and the conductive material. In some embodiments, the binder for forming the anode may include, e.g., an aqueous binder such as styrene-butadiene rubber (SBR) for compatibility with the carbon-based active material, and may be used together with the thickener such as carboxymethyl cellulose (CMC).

A separator 140 may be interposed between the cathode 100 and the anode 130. The separator 140 may include a porous polymer film formed of a polyolefin polymer such as an ethylene homopolymer, a propylene homopolymer, an ethylene/butene copolymer, an ethylene/hexene copolymer, an ethylene/methacrylate copolymer, or the like. The separator 140 may also include a nonwoven fabric formed of a high-melting point glass fiber, a polyethylene terephthalate fiber, or the like.

In example embodiments, an electrode cell may be defined by the cathode 100, the anode 130 and the separator 140, and a plurality of the electrode cells may be repeatedly stacked to form an electrode assembly 150 having, e.g., a jelly-roll shape. For example, the electrode assembly 150 may be prepared by winding, stacking, folding, etc., of the separator 140.

The electrode assembly 150 may be accommodated in a case 160 together with an non-aqueous electrolyte solution, thereby defining a lithium secondary battery.

In example embodiments, the non-aqueous electrolyte solution may include an organic solvent and a lithium salt.

In some embodiments, the lithium salt may be expressed as Li⁺X⁻. For example, X⁻ may be any one of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

In an embodiment, the lithium salt may include at least one selected from the group consisting of lithium tetrafluoroborate (LiBF₄), lithium hexafluorophosphate (LiPF₆) and lithium difluorophosphate (LiPO₂F₂). These may be used alone or in a combination thereof. For example, the lithium salt may include lithium hexafluorophosphate (LiPF₆).

In some embodiments, a concentration of the lithium salt in the non-aqueous electrolyte solution may exceed 1 M.

For example, if the concentration of the lithium salt is less than 1 M, a lithium ion conductivity may be lowered to reduce the capacity and power properties. For example, when the first cathode active material having a relatively low electrical conductivity is used, the concentration of the lithium salt may be increased to achieve sufficient power properties.

For example, if the concentration of the lithium salt is excessively increased, side reactions with the cathode active material may be excessively increased during charge and discharge of the secondary battery. Accordingly, the amount of gas generation may be increased to reduce the capacity retention of the secondary battery.

In an embodiment, the concentration of the lithium salt may be in a range from 1.02 M to 1.18 M, from 1.03 M to 1.17 M, from 1.05 M to 1.15 M, from 1.07 M to 1.13 M, or 1.08 M to 1.12 M. In this range, a conductivity of the electrolyte solution and a mobility of the lithium ions can both be enhanced. Accordingly, the capacity and power properties of the secondary battery may be improved, while further enhancing high-temperature stability.

In some embodiments, the organic solvent may include a carbonate-based solvent such as ethylene carbonate (EC), propylene carbonate (PC), dimethyl carbonate (DMC), diethyl carbonate (DEC), ethyl methyl carbonate (EMC), etc.; an ester-based solvent such as methyl propionate, ethyl propionate, ethyl acetate, propyl acetate, butyl acetate, butyrolactone, caprolactone, valerolactone, etc.; an ether-based solvent such as dibutyl ether, tetraethylene glycol dimethyl ether (TEGDME), diethylene glycol dimethyl ether (DEGDME), tetrahydrofuran (THF), etc.; an alcohol-based solvent such as ethyl alcohol, isopropyl alcohol, etc.; a ketone-based solvent such as cyclohexanone; an aprotic solvent such as an amide-based solvent (e.g., dimethylformamide), a dioxolane-based solvent (e.g., 1,3-dioxolane), a sulfolane-based solvent, a nitrile-based solvent, etc.

In an embodiment, the organic solvent may include at least one selected from the group consisting of propylene carbonate (PC), ethylene carbonate (EC), butylene carbonate, diethyl carbonate (DEC), dimethyl carbonate (DMC) and ethylmethyl carbonate (EMC). These may be used alone or in a combination of two or more therefrom. For example, the organic solvent may include a mixture of ethylene carbonate and ethylmethyl carbonate.

In some embodiments, the non-aqueous electrolyte solution may further include an additive.

The additive may include at least one selected from the group consisting of a cyclic carbonate compound, a fluorine-substituted carbonate compound, a sultone compound, a cyclic sulfate compound, a cyclic sulfite compound, a phosphate compound and a borate compound.

In some embodiments, the additive may include the cyclic carbonate compound. For example, the additive may include vinylene carbonate (VC) or vinyl ethylene carbonate (VEC). Accordingly, the cyclic carbonate compound may be decomposed in the electrolyte solution so that an SEI layer may be more stably formed.

In some embodiments, the additive may include a fluorine-substituted carbonate compound. For example, the additive may include fluoroethylene carbonate (FEC).

In one embodiment, the additive may include both the fluorine-substituted carbonate compound and the cyclic carbonate compound. For example, the cyclic carbonate compound may be a non-fluorine-substituted cyclic carbonate compound.

For example, the additive may include both vinyl ethylene carbonate (VEC) and fluoroethylene carbonate (FEC). Accordingly, the carbonate compound may be decomposed in the electrolyte solution to form a more stable SEI layer. Thus, the secondary battery having improved life-span properties at both high and low temperatures may be provided.

In an embodiment, the additive may include both the cyclic carbonate compound and the phosphate compound. For example, the phosphate compound may include lithium difluoro phosphate (LiDFP). Accordingly, the side reactions of the cathode active material may be further suppressed, and gas generation due to the side reactions may be further suppressed.

In an embodiment, the additive may include both the cyclic carbonate compound and the sultone compound. For example, the sultone compound may include 1,3-propane sultone or 1,3-propene sultone. For example, the additive may include both 1,3-propane sultone and 1,3-propene sultone. Accordingly, an interfacial resistance of the electrode may be reduced and the conductivity may be improved. Thus, the life-span and power properties of the secondary battery may be further improved.

In an embodiment, the additive may include at least one selected from the group consisting of vinyl ethylene carbonate (VEC), vinyl ethylene carbonate (VC), fluoroethylene carbonate (FEC), lithium difluorophosphate (LiDFP), 1,3-propane sultone and 1,3-propene sultone. These may be used alone or in a combination of two or more therefrom.

For example, the additive may include vinyl ethylene carbonate (VEC), vinyl ethylene carbonate (VC), fluoroethylene carbonate (FEC), lithium difluorophosphate (LiDFP), 1,3-propane sultone and 1,3-propene sultone. Accordingly, the high-capacity and high-power properties of the secondary battery may be enhanced while further improving the capacity retention at high temperature.

In some embodiments, a content of the additive may be in a range from 0.1 wt % to 10 wt %, from 0.15 wt % to 8 wt %, from 0.2 wt % to 7 wt %, from 0.25 wt % to 6 wt %, from 0.3 wt % to 5 wt %, or from 0.5 wt % to 5 wt %, based on a total weight of the non-aqueous electrolyte solution. In this range, thermal and mechanical stability may be increased while enhancing the electrical conductivity.

In an embodiment, a content of the cyclic carbonate compound based on the total weight of the non-aqueous electrolyte solution may be in a range from 0.1 wt % to 10 wt %, from 0.2 wt % to 5 wt %, from 0.3 wt % to 3 wt %, or from 0.5 wt % to 2 wt %.

In an embodiment, a content of the fluorine-substituted carbonate compound based on the total weight of the non-aqueous electrolyte solution may be in a range from 0.1 wt % to 10 wt %, from 0.2 wt % to 5 wt %, from 0.3 wt % to 3 wt %, or from 0.5 wt % to 2 wt %.

In an embodiment, a sum of the contents of the carbonate-based compound based on the total weight of the non-aqueous electrolyte solution may be in a range from 0.2 wt % to 10 wt %, from 0.5 wt % to 8 wt %, from 0.5 wt % to 5 wt %, or from 1 wt % to 4 wt %. In the above range, structural stability may be improved while further improving the conductivity of lithium ions in the above-described concentration range of the lithium salt.

In an embodiment, a content of each of the phosphate-based compound and the sultone-based compound based on the total weight of the non-aqueous electrolyte solution may be in a range from 0.05 wt % to 10 wt %, from 0.1 wt % to 3 wt %, from 0.2 wt % to 1 wt %, or from 0.3 wt % to 0.8 wt %. In the above range, the gas generation due to the side reactions with the cathode active material may be further suppressed while reducing the interfacial resistance of the electrode. Accordingly, capacity, power and life-span properties of the secondary battery at high temperature may be further improved.

The lithium secondary battery according to embodiments may include electrode leads 107 and 127 connected to the electrodes 100 and 130 and protruding to an outside of the case 160.

For example, the electrode leads may include a cathode lead 107 connected to the cathode 100 and an anode lead 127 connected to the anode 130 which protrude to the outside of the case 160.

For example, the cathode 100 and the cathode lead 107 may be electrically connected to each other. The anode 130 and the anode lead 127 may be electrically connected to each other.

For example, the cathode lead 107 may be electrically connected to the cathode current collector 105. The anode lead 127 may be electrically connected to the anode current collector 125.

The cathode current collector 105 of the cathode 100 and the anode current collector 125 of the anode 130 may each include a notched portion. The notched portion may be provided as, e.g., an electrode tab. The notched portion may include a cathode notched portion protruding from the cathode current collector 105 and an anode notched portion protruding from the anode current collector 125.

For example, the cathode current collector 105 may include a protrusion (a cathode tab) at one side thereof. The cathode active material layer 110 may not be disposed on the cathode tab. The cathode tab may be integral with the cathode current collector 105 or may be connected by, e.g., welding. The cathode current collector 105 and the cathode lead 107 may be electrically connected through the cathode tab.

The anode current collector 125 may include a protrusion (an anode tab) at one side thereof. The anode active material layer 120 may not be disposed on the anode tab. The anode tab may be integral with the anode current collector 125 or may be connected by, e.g., welding. The anode current collector 125 and the anode lead 127 may be electrically connected through the anode tab.

In an embodiment, the electrode assembly 150 may include a plurality of cathodes and a plurality of anodes. For example, the cathode and the anode may be alternately and repeatedly stacked, and the separator may be interposed between the cathode and the anode. Accordingly, the lithium secondary battery according to an embodiment may include a plurality of the cathode tabs and a plurality of the anode tabs protruding from each of the plurality of the cathodes and a plurality of the anodes.

In an embodiment, the cathode tabs (or the anode tabs) may be stacked, pressed, and welded to provide a cathode tab stack (or an anode tab stack). The cathode tab stack may be electrically connected to the cathode lead 107. The anode tab stack may be electrically connected to the anode lead 127.

The lithium secondary battery may be manufactured in, e.g., a cylindrical type, a prismatic type, a pouch type, or a coin type.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Examples 1 to 6 and Comparative Examples 1 to 4

### (1) Preparation of First Cathode Active Material

A first cathode active material precursor mixture was prepared by mixing Li₂CO₃, Fe₂PO₄, Mn₃O₄, LiH₂PO₄, and glucose (C₆H₁₂O₆) and citric acid (C₆H₈O₇) as additives. The mixture was calcined at about 650° C. to prepare a first cathode active material including lithium metal phosphate particles having a composition of LiMn_{0.7}Fe_{0.3}PO₄.

A particle diameter (D50) of the lithium metal phosphate particles was measured using a laser diffraction method. The particle diameter (D50) of the lithium metal phosphate particles was 0.87 μm.

### (2) Preparation of Second Cathode Active Material

NiSO₄, CoSO₄ and MnSO₄ were mixed in distilled water bubbled with N₂ for 24 hours to remove dissolved oxygen, so that a mixed solution was prepared. The mixed solution, NaOH and NH₄OH were input in a reactor, and a co-precipitation reaction was performed for 60 hours to obtain Ni_{0.6}Co_{0.1}Mn_{0.3}(OH)₂ as a transition metal precursor.

Lithium hydroxide and the transition metal precursor were mixed in a molar ratio of 1.05:1, placed in a firing furnace, heated to a temperature of 670° C. to 750° C. at a rate of 2° C./min, and maintained at 670 to 750° C. for 10 hours. Oxygen was continuously passed through the reactor at a flow rate of 20 L/min during the heating and maintenance period. After the firing, the reactor was naturally cooled to room temperature, and then pulverized and classified to obtain a second cathode active material including lithium transition metal oxide particles of LiNi_{0.6}Co_{0.1}Mn_{0.3}O₂.

The cross-section of the lithium transition metal oxide particles was observed using a scanning electron microscope (SEM), confirming that the lithium transition metal oxide particles were single particles.

A particle diameter (D50) of the lithium transition metal oxide particles was measured using a laser diffraction method. The particle diameter (D50) of the lithium transition metal oxide particles was 3.5 μm.

### (3) Fabrication of Lithium Secondary Battery

A lithium secondary battery was manufactured using the first and second cathode active materials obtained as described above.

Specifically, the first and second cathode active materials were mixed in ratios shown in Table 1 below to prepare a cathode active material mixture. The cathode active material mixture, carbon black as a conductive agent, and PVDF as a binder were mixed in a mass ratio of 97.6:1.1:1.3 to prepare a cathode slurry. The cathode slurry was coated on an aluminum current collector, dried, and pressed to obtain a cathode. A target electrode density after the pressing of the cathode was adjusted to 2.8 g/cc.

An anode active material containing artificial graphite and natural graphite in a mass ratio of 7:3, styrene-butadiene rubber (SBR) as a binder, and carboxymethyl cellulose (CMC) as a thickener were mixed in a mass ratio of 97.6:1.2:1.2 to prepare an anode slurry. The anode slurry was coated on a copper current collector, dried and pressed to obtain an anode. A target electrode density after the pressing of the anode was adjusted to 1.6 g/cc.

The cathode and the anode prepared as described above were notched to a predetermined size and stacked, then an electrode cell was fabricated by interposing a separator (polyethylene, thickness: 12.5 μm) between the cathode and the anode. Thereafter, each of tab portions of the cathode and the anode was welded. The assembly of the welded cathode/separator/anode was placed in a pouch, and two sides except for an electrolyte injection side were sealed. An electrolyte solution was injected through the electrolyte injection side and electrolyte injection side was sealed, followed by aging for 24 hours or more so that the electrolyte solution impregnated an inside of the electrode.

An additive and LiPF₆ were dissolved in a mixed solvent of EC/EMC (25/75; volume ratio) to form the electrolyte solution. 1.0 wt % of vinyl ethylene carbonate (VEC), 1.0 wt % of fluoroethylene carbonate (FEC), 0.5 wt % of lithium difluorophosphate (LiDFP), 0.3 wt % of 1,3-propene sultone (PRS), and 0.5 wt % of 1,3-propane sultone (PS) as the additive were used based on a total weight of the electrolyte solution. A concentration of LiPF₆ was adjusted as shown in Table 1.

The secondary battery prepared as described above were subjected to a formation charge and discharge (charge conditions: CC-CV 0.33C 4.3V 0.05C CUT-OFF; discharge conditions: CC 0.33C 2.5V CUT-OFF).

In Table 1, a weight ratio of the cathode active material represents a ratio of a weight of the first cathode active material relative to a weight of the second cathode active material included in the cathode.

In Comparative Example 3, the second cathode active material was not included.

### Example 7

The first cathode active material, the second cathode active material and the lithium secondary battery were prepared by the same method as that in Example 1, except that LiNi_{0.77}Co_{0.03}Mn_{0.2}O₂ was obtained as the lithium transition metal oxide particle in the preparation of the second cathode active material.

### Example 8

The first cathode active material, the second cathode active material and the lithium secondary battery were prepared using the same method as that in Example 1, except that LiNi_{0.88}Co_{0.1}Mn_{0.02}O₂ was obtained as the lithium transition metal oxide particle in the preparation of the second cathode active material.

TABLE 1

| | weight ratio of | concentration of | Ni molar |
|---|---|---|---|
| | cathode active material | lithium salt (M) | ratio (mol %) |
| Example 1 | 2.3 | 1.1 | 60 |
| Example 2 | 1.5 | 1.1 | 60 |
| Example 3 | 4 | 1.1 | 60 |
| Example 4 | 2.3 | 1.15 | 60 |
| Example 5 | 2.3 | 1.05 | 60 |
| Example 6 | 2.3 | 1.2 | 60 |
| Example 7 | 2.3 | 1.1 | 77 |
| Example 8 | 2.3 | 1.1 | 88 |
| Comparative | 0.4 | 1.1 | 60 |
| Example 1 | | | |
| Comparative | 1 | 1.1 | 60 |
| Example 2 | | | |
| Comparative | — | 1.1 | — |
| Example 3 | | | |
| Comparative | 2.3 | 1.0 | 60 |
| Example 4 | | | |

### Experimental Example

### (1) Evaluation on Rapid Charge/Discharge Properties During Repeated Charge/Discharge (25° C.)

Rapid charge/discharge properties of the lithium secondary batteries of Examples and Comparative Examples were evaluated at 25° C. in a range of SOC (State of Charge) 10%-80%.

Specifically, the batteries were charged to by C-rates of 2.9C/2.75C/2.5C/2.25C/2.0C/1.8C/1.6C/1.45C/1.3C/1.0C according to a stepwise charging method to reach a voltage corresponding to SOC 80% within 20 minutes, then discharged at 0.5C under constant current (CC) conditions to a voltage corresponding to SOC 10%.

An initial discharge capacity was measured, and a discharge capacity after 500 cycles of charge/discharge was expressed as a percentage (%) of the initial discharge capacity to measure a capacity retention (%).

An initial internal resistance (DC-IR) was measured, and an internal resistance after 500 cycles of charge/discharge was expressed as a percentage (%) of the initial internal resistance to measure a resistance increase ratio (%) and evaluate rapid charge/discharge properties.

The results are shown in Table 2.

TABLE 2

| | rapid charge/discharge properties (25° C.) | |
|---|---|---|
| | capacity retention (%) | resistance increase ratio (%) |
| Example 1 | 93.6 | 104.4 |
| Example 2 | 94.0 | 108.9 |
| Example 3 | 93.1 | 105.8 |
| Example 4 | 93.9 | 104.6 |
| Example 5 | 93.4 | 104.4 |
| Example 6 | 94.0 | 104.1 |
| Example 7 | 93.8 | 109.2 |
| Example 8 | 92.5 | 103.2 |
| Comparative | 93.5 | 122.1 |
| Example 1 | | |
| Comparative | 93.5 | 127.4 |
| Example 2 | | |
| Comparative | 89.8 | 183.0 |
| Example 3 | | |
| Comparative | 90.1 | 108.6 |
| Example 4 | | |

Referring to Table 2, in Examples where the weight ratio of the first cathode active material relative to the second cathode active material was adjusted to a range of 1.5 to 9, improved rapid charge/discharge properties were provided compared to those from Comparative Examples.

In Comparative examples 1 and 2 where the weight ratio of the first cathode active material relative to the second cathode active material was less than 1.5, degraded capacity retentions during rapid charge/discharge were provided compared to those from Examples. Further, the resistance increase ratio during rapid charge/discharge of Comparative Example 3 devoid of the second cathode active material exceeded 180%.

In Comparative example 4 where the lithium salt concentration was 1.0 M, the capacity retention was further decreased compared to those from Examples.

### (2) Evaluation on High-Temperature Storage Properties (60° C.)

The lithium secondary batteries of Examples and Comparative Examples were charged at 0.3C CC-CV (4.3 V, 0.05C cut-off), then discharged at 0.3C CC (2.5V cut-off) so that an initial discharge capacity was measured. The lithium secondary batteries charged at room temperature at 4.3 V and 0.33 C CC-CV (0.05 C cut-off), and then stored in an air-conditioned chamber at 60° C. for 24 weeks. After the high-temperature storage, a discharge capacity was measured after a CC discharge at 0.33 C (2.5 V cut-off). A storage capacity retention was measured by expressing the discharge capacity after high-temperature storage as a percentage (%) compared to the initial discharge capacity.

In Example 8, the lithium secondary battery was stored in an air-conditioned chamber at 60° C. for 20 weeks after charging, and the storage capacity retention was measured.

After the high-temperature storage, an amount of gas generation was measured by measuring a length of a remaining sealing portion after the sealing portion of the pouch was pushed out by the gas to evaluate the high-temperature storage properties.

The results are shown in Table 3.

TABLE 3

| | high-temperature storage properties (60° C.) | |
|---|---|---|
| | storage capacity | length of remaining |
| | retention (%) | sealing portion (mm) |
| Example 1 | 92.0 | 2.0 |
| Example 2 | 91.2 | 2.0 |
| Example 3 | 91.6 | 2.0 |
| Example 4 | 92.1 | 2.0 |
| Example 5 | 91.8 | 2.0 |
| Example 6 | 91.3 | 0.5 |
| Example 7 | 91.8 | Vent (no remaining sealing portion) |
| Example 8 | 91.5 | Vent (no remaining sealing portion) |
| | | @ 20 weeks |
| Comparative | 86.2 | 1.5 |
| Example 1 | | |
| Comparative | 89.4 | 1.5 |
| Example 2 | | |
| Comparative | 73.8 | 2.0 |
| Example 3 | | |
| Comparative | 89.7 | 2.0 |
| Example 4 | | |

Referring to Table 3, in Examples where the weight ratio of the first cathode active material relative to the second cathode active material was adjusted to a range of 1.5 to 9, improved high-temperature storage properties were provided compared to those from Comparative Examples.

In Example 8 where the molar ratio of nickel to the total moles of metals excluding lithium contained in the lithium transition metal oxide particles exceeded 0.8, the gas generation increased after the high-temperature storage to cause ventilation after 20 weeks. Accordingly, the length of the remaining sealing portion of the pouch was not measured.

In Comparative Examples, the amount of gas generation was increased and the length of the remaining sealing portion was decreased.

In Comparative Examples 1 and 2 where the weight ratio of the first cathode active material relative to the second cathode active material was less than 1.5, the storage capacity retentions at high temperature were degraded compared to those from Examples. Furthermore, the high-temperature storage capacity retention of Comparative Example 3 devoid of the second cathode active material was decreased to less than 80%.

In Comparative Example 4 where the lithium salt concentration was 1.0 M, the high-temperature storage capacity retention was further reduced compared to those from Examples.

The above description are merely intended to provide examples of applying the principles of the present disclosure, and other elements may be included without departing from the scope of the present disclosure.

What is claimed is:

1. A lithium secondary battery, comprising:
a cathode comprising a cathode active material layer that includes a first cathode active material including lithium metal phosphate particles, and a second cathode active material including lithium transition metal oxide particles;
an anode facing the cathode; and
a non-aqueous electrolyte solution including an organic solvent and a lithium salt,
wherein a weight ratio of the first cathode active material relative to the second cathode active material in the cathode active material layer is in a range from 1.5 to 9, and
a concentration of the lithium salt in the non-aqueous electrolyte solution exceeds 1 M.

2. The lithium secondary battery of claim 1, wherein the lithium metal phosphate particles contain manganese.

3. The lithium secondary battery of claim 1, wherein the lithium transition metal oxide particles have a single particle shape.

4. The lithium secondary battery of claim 1, wherein a molar ratio of nickel based on total moles of metal elements excluding lithium contained in the lithium transition metal oxide particles is 0.8 or less.

5. The lithium secondary battery of claim 1, wherein a molar ratio of nickel based on total moles of metal elements excluding lithium contained in the lithium transition metal oxide particles is in a range from 0.5 to 0.7.

6. The lithium secondary battery of claim 1, wherein the weight ratio of the first cathode active material relative to the second cathode active material in the cathode active material layer is in a range from 1.7 to 4.

7. The lithium secondary battery of claim 1, wherein an average particle diameter (D50) of the first cathode active material is in a range from 0.3 μm to 1.5 μm.

8. The lithium secondary battery of claim 1, wherein a specific surface area of the first cathode active material is in a range from 10 m²/g to 17 m²/g.

9. The lithium secondary battery of claim 1, wherein an average particle diameter (D50) of the second cathode active material is in a range from 2 μm to 10 μm.

10. The lithium secondary battery of claim 1, wherein the lithium salt includes at least one selected from the group consisting of lithium tetrafluoroborate (LiBF₄), lithium hexafluorophosphate (LiPF₆) and lithium difluorophosphate (LiPO₂F₂).

11. The lithium secondary battery of claim 1, wherein a concentration of the lithium salt in the non-aqueous electrolyte solution is in a range from 1.05 M to 1.15 M.

12. The lithium secondary battery of claim 1, wherein the organic solvent includes at least one selected from the group consisting of propylene carbonate (PC), ethylene carbonate (EC), butylene carbonate, diethyl carbonate (DEC), dimethyl carbonate (DMC) and ethylmethyl carbonate (EMC).

13. The lithium secondary battery of claim 1, wherein the non-aqueous electrolyte solution further includes an additive including at least one selected from the group consisting of a cyclic carbonate compound, a fluorine-substituted carbonate compound, a sultone compound, a cyclic sulfate compound, a cyclic sulfite compound, a phosphate compound and a borate compound.

14. The lithium secondary battery of claim 13, wherein the additive includes at least one selected from the group consisting of vinylene carbonate (VC), vinyl ethylene carbonate (VEC), fluoroethylene carbonate (FEC), lithium difluoro phosphate (LiDFP), 1,3-propane sultone and 1,3-propene sultone.

15. The lithium secondary battery of claim 13, wherein a content of the additive is in a range from 0.1 wt % to 10 wt % based on a total weight of the non-aqueous electrolyte solution.
